(19) United States
(12) Patent Application Publication
(10) Pub. No.: US 2008/0128115 A1
(43) Pub. Date: Jun. 5, 2008

(54) Radiator Module for Fuel Cell Vehicles

(76) Inventor: Seung Yong Lee, Yongin-si (KR)

Correspondence Address: MORGAN, LEWIS & BOCKIUS LLP (SF), One Market, Spear Street Tower, Suite 2800, San Francisco, CA, 94105, US

(21) Appl. No.: 11/842,463

(22) Filed: Aug. 21, 2007

(30) Foreign Application Priority Data
Dec. 5, 2006 (KR) 10-2006-0122271

(51) Int. Cl. F28F 27/00; B60K 11/02

(52) U.S. Cl. 165/96

(57) ABSTRACT

The present invention relates to a radiator module including a water pump and a pump controller which are integrally configured with each other. The present invention provides a radiator module for a fuel cell vehicle in which with the trend in which miniaturization and modulization of fuel cell components become one of indispensable factors for commercialization of a fuel cell vehicle, an electronic water pump and a radiator unit are integrally formed into a single module in a cooling water circulation system to reduce the system space, and a pump controller for controlling the water pump is built in the radiator module, thereby promoting improvement of cooling performance.

### CROSS-REFERENCE TO RELATED APPLICATIONS

This application claims the benefit under 35 U.S.C. §119(a) of Korean Patent Application No. 10-2006-0122271, filed in the Korean Intellectual Property Office on Dec. 5, 2006, the entire contents of which are incorporated herein by reference.

### BACKGROUND OF THE INVENTION

(a) Field of the Invention

The present invention relates to a radiator module constituting a cooling system of fuel cell vehicles and more particularly, to a novel type of radiator module including a water pump and a pump controller which are integrally configured with each other to thereby improve the spatial efficiency, the cooling performance and the reduction of a parts price according to modulization.

(b) Background Art

In general, a fuel cell is an energy conversion system which generates electric power as a part of a chemical reaction between gas and electrolyte of gas oil or industrial fuel so as to directly convert chemical energy generated by fuel into electric energy.

The fuel cell has a structure in which the electrolyte is sandwiched between two electrodes. When oxygen and hydrogen flows into respective electrodes, electricity, heat and water are created. Such a fuel cell is used as a system for supplying electric power to an industrial field that cannot substantially utilize an internal combustion engine such as a spacecraft, an electric vehicle or the like.

The fuel cell may use a variety of gases such as natural gas, methanol, gasoline and the like. In this case, fuel is modified into hydrogen via a fuel converter.

Currently, it is expected that an electric vehicle using a fuel cell would substantially replace an internal combustion vehicle as an interest in energy efficiency and environmental pollution problem increases day by day.

A vehicle using such a fuel cell generates electric energy with hydrogen supplied to a fuel electrode of a fuel cell stack and water supplied to an air electrode. This electric vehicle is driven by a motor using the generated electric energy to travel.

For example, the hydrogen supplied to the fuel electrode of the fuel cell stack is decomposed into a hydrogen ion (H⁺) and an electron (e⁻) and then the hydrogen ion is selectively transferred to the air electrode via a polymer electrolyte membrane.

Current is generated in a conductive wire that interconnects the fuel electrode and the air electrode. The electron which has moved to the air electrode reacts with the air supplied to the air electrode to generate water and heat, so that non-reacted hydrogen and air is discharged to the outside.

FIG. 1 is a schematic view illustrating the configuration of a cooling system of a fuel cell vehicle according to a prior art.

As shown in FIG. 1, the cooling system of the fuel cell vehicle includes a cooling water circulation system and a cooling water condensation system. Herein, only the cooling water circulation system will be described.

The cooling water circulation system is configured such that cooling water passes through a radiator 100 and a fuel cell stack 110. The cooling water passing through the fuel cell stack 110 absorbs a heat generated by a reaction between air and hydrogen, and then is re-cooled in the radiator 100 so as to be re-supplied to the fuel cell stack 110.

Herein, non-explained reference numeral 120 denotes a water pump, and reference numerals 130 and 140 denote a reservoir and a fan respectively.

In such a cooling system, cooling water is used to cool the heat of reaction. Ultra pure water is used as cooling water for the fuel cell stack so as to humidify the inside of the fuel cell stack, dissimilar to a general vehicle.

In case where the cooling system has a structure in which the cooling water directly humidifies the inside of the fuel cell stack, it is designed to maintain a suitable water balance for humidification in terms of an operational characteristics of the stack.

In addition, in case of an 80 Kw fuel cell vehicle, a radiator unit is mounted to radiate a heat output of 40 Kw. The actual operating temperature of a fuel cell is approximately 70° C. so that a problem associated with cooling might occur since a difference between the environmental temperature and the operating temperature is not large.

Accordingly, a large-capacity radiator and a large-flow rate water pump are needed. However, in case that the components are large-scaled, it is difficult to install them inside the electric vehicle. Moreover, it is difficult to control high-temperature heat generated from a pump controller and a motor due to the scale-up of the water pump.

Resultantly, the modulization of fuel cell components become one of indispensable factors for commercialization of a fuel cell vehicle, but the scale-up of the components and the like is a disincentive to modulization of the fuel cell components, considering space and cost.

The information disclosed in this Background Art of the invention section is only for enhancement of understanding of the background of the invention and should not be taken as an acknowledgement or any form of suggestion that this information forms the prior art that is already known to a person skilled in the art.

### SUMMARY OF THE INVENTION

Accordingly, the present invention has been made in an effort to solve the aforementioned problems occurring in the prior art, and it is an object of the present invention to provide a radiator module for a fuel cell vehicle in which as the trend that miniaturization and modulation of fuel cell components become one of indispensable factors for commercialization of a fuel cell vehicle, an electronic water pump and a radiator unit are integrally configured into a single module in a cooling water circulation system to reduce the system space, and the water pump and a pump controller for controlling the water pump are integrally configured with each other in such a fashion that the pump controller is built in the radiator module, thereby improving cooling performance of the fuel cell vehicle.

To accomplish the above object, the present invention provides a radiator module for fuel cell vehicle, comprising: a radiator unit mounted in a cooling system of the fuel cell vehicle, the radiator unit including an inlet port, an outlet port and a radiator fan; at least a water pump installed inside the inlet port and the outlet port of the radiator unit, respectively; and a pump controller mounted at one side of a rear portion of the radiator module for controlling the water pumps, the pump controller being installed to be cooled by a flow of air generated by the radiation fan of the radiator unit.

In another embodiment, each of the water pumps may be installed at the radiator module in such a fashion that an impeller thereof is disposed substantially on the co-plane of a front wall surface of the radiator module substantially along a perpendicular axis extending from a front wall surface of the radiator module.

In a preferred embodiment, the radiator unit may comprise at least a fluid flow guide vane configured convexly in a streamlined and tapered shape on a rear wall surface thereof in such a fashion as to be disposed opposite to the inlet port and the outlet port, respectively, so as to induce a flow of water therethrough.

In another preferred embodiment the pump controller may comprise a radiation block having a plurality of radiation fins formed at least at one side thereof.

In a further embodiment, the water pump installed inside the outlet port of the water pumps is configured to rotate about at a speed 200 to 500 rpm lower than that of the water pump installed inside the inlet port.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic view illustrating the configuration of a cooling system of a fuel cell vehicle in accordance with a prior art;

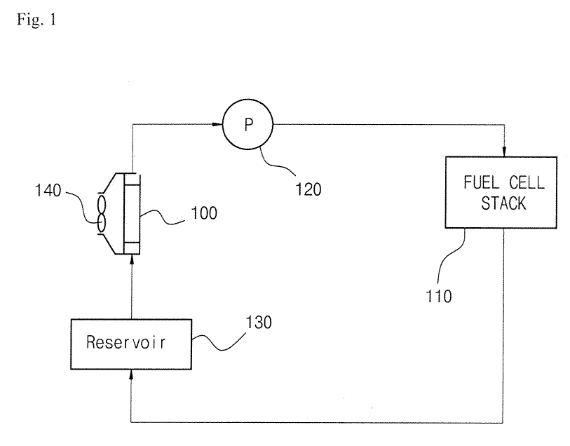

FIG. 2 is an outer perspective view illustrating a radiator module in accordance with a preferred embodiment of the present invention;

FIG. 3 is a front view illustrating a radiator module in accordance with a preferred embodiment of the present invention; and

FIG. 4 is a cross-sectional side view illustrating a radiator module in accordance with a preferred embodiment of the present invention.

### DETAILED DESCRIPTION

References will now be made in detail to the preferred embodiments of the present invention, examples of which are illustrated in the drawings attached hereinafter, wherein like reference numerals refer to like elements throughout. The embodiments are described below so as to explain the present invention by referring to the figures.

Now, a radiator module according to a preferred embodiment of the present invention will be described hereinafter in detail with reference to the accompanying drawings.

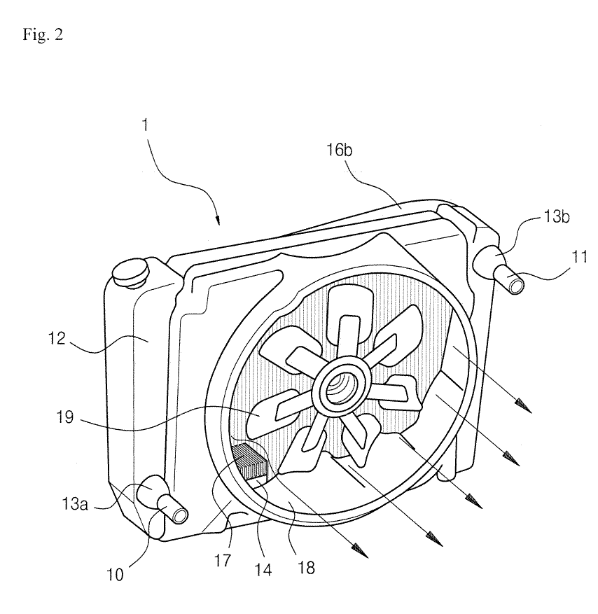

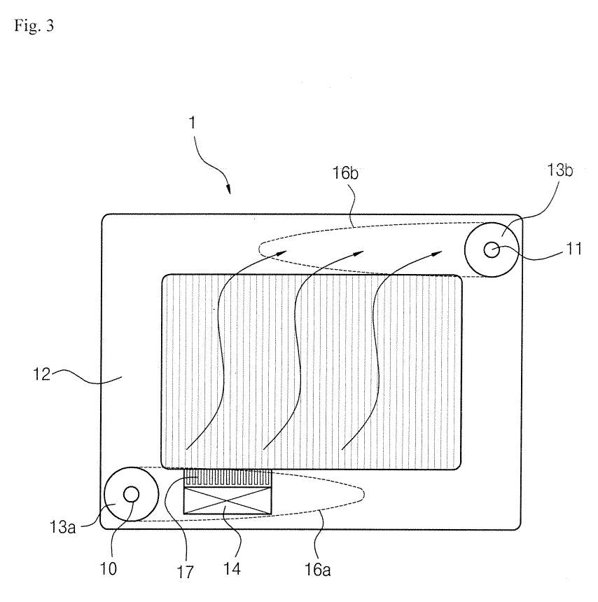

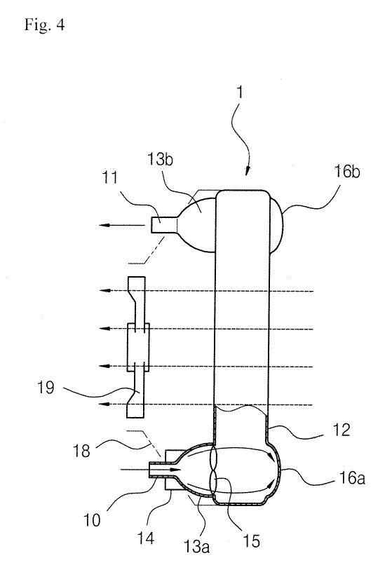

FIG. 2 is an outer perspective view illustrating an exemplary radiator module in accordance with a preferred embodiment of the present invention, FIG. 3 is a front view illustrating an exemplary radiator module which removed the radiation fan 19 and the shroud 18 in accordance with a preferred embodiment of the present invention, and FIG. 4 is a cross-sectional side view illustrating an exemplary radiator module in accordance with a preferred embodiment of the present invention.

As shown in FIGS. 2 to 4, the radiator module 1 is configured such that water pumps 13a and 13b and a pump controller 14 for controlling the water pumps are mounted integrally to be modulized in a main body of the radiator module 1 so that each system of a fuel cell vehicle, particularly a cooling system can be implemented in a compact structure.

To this end, each of two water pumps 13a and 13b is mounted at the inner portions of an inlet port 10 and an outlet port 11 of the radiator unit 12. A pump controller 14 is mounted at one side of a rear portion of the radiator module 1 in such a fashion as to be integrally attached to the radiator unit 12 so as to control the water pumps 13a and 13b.

In this way, the two water pumps 13a and 13b are concurrently applied to the inlet port 10 and the outlet port 11 of the radiator unit 12 to thereby implement a low head-high flow design of the water pumps which are connected in series and thus prevent a structural damage of the radiator unit 12 occurring due to an increase in flow rate and a pressure difference in a stack separation plate (not shown) of a fuel cell stack.

In this case, while the water pumps 13a and 13b are installed inside the inlet port 10 and outlet port 11 of the radiator unit 12, their impellers 15 are positioned substantially on the co-plane of a front wall surface of the radiator module 1 substantially along a perpendicular axis extending from a front wall surface of the radiator module 1.

If each impeller 15 is positioned outwardly from the front wall surface of the radiator module 1, this arrangement might increase the volume of the radiator module 1. On the contrary, if each impeller 15 is positioned inwardly from the front wall surface of the radiator module 1, backpressure between the inlet port 10 and the outlet port 11 is increased to result in a drop in the efficiency of pump performance. Thus, it is preferable to dispose the impellers 15 substantially on the co-plane of a front wall surface of the radiator module 1 substantially along a perpendicular axis extending from a front wall surface of the radiator module 1.

Preferably, in a method of controlling the water pumps, the water pump 13b installed inside the outlet port 11 of the water pump 13b is configured to rotate at a speed of about 200 to 500 rpm lower than that of the water pump 13a installed inside the inlet port 10.

This configuration is aimed to supply the time delay sufficient enough to fill the water in flow passages between the inlet port 10 and the outlet port 11 of the radiator unit and to suppress a cavitations phenomenon. That is, the difference of rotational speed between the water pumps 13a and 13b gives water some time delay to give the water filled enough in the passage of water. This time delay also makes water adapted without making voids or bubbles in the flow of water to prevent the bubbles from producing a shock wave usually occurring from cavitations phenomenon.

In addition, a pump controller 14 for controlling the water pumps 13a and 13b is mounted at one side of a rear portion of the radiator module 1, for example, inwardly from a shroud 18 at a position in contact with air passing through a main body of the radiator unit 12 as shown in FIG. 2.

The pump controller 14 is a controller having the same function as that of an ordinary pump controller, and in another embodiment, may be mounted in such a fashion as to be supported outwardly from the front wall of the radiator module 1 by means of a bracket and the like (not shown).

Accordingly, since the pump controller 14 is installed inwardly from the shroud 18, it can be expected that the pump controller 14 would be cooled by a flow of air generated by radiator fan 19 of the radiator unit upon the operation of a radiator fan 19 even without an additional power.

In an embodiment, a radiation block 17 having a plurality of radiation fins is mounted integrally at a top portion of the pump controller 14 to thereby further improve a cooling efficiency through the radiation action of the radiation fins in contact with air as shown in FIG. 3.

Moreover, in an exemplary embodiment, the radiator module 1 comprises a pair of fluid flow guide vanes 16a and 16b mounted on a rear wall surface thereof so as to induce a flow of water therethrough as shown in FIGS. 3 and 4.

The fluid flow guide vanes 16a and 16b are configured convexly in a streamlined and tapered shape on a rear wall surface of the radiator module 1 in such a fashion as to be positioned opposite to the inlet port 10 and the outlet port 11 respectively, so as to horizontally induce the flow of water therethrough.

Such fluid flow guide vanes 16a and 16b serve to prevent an abrupt change of water pressure caused by a shortened length between an inlet port 10 and an outlet port 11 and evenly distribute water wholly in the radiator unit 12.

Particularly, the fluid flow guide vanes 16a and 16b takes a streamlined and tapered shape in which a width is gradually narrowed as it goes toward one side end horizontally, for example, as it goes from a discharge side or an intake side of the water pump toward an opposite side to the discharge or intake side so that progression of water can be induced more smoothly with adapting to the pressure gradient.

Therefore, in case of a fuel cell vehicle that a research is actively in progress to gradually make a fuel cell system compact by applying the scale-down of a pump and a dedicated platform due to a size and space-associated problem and under a current status in which a fuel cell system itself, a related controller and electrical equipment encounters a cooling-related problem, application of a radiator module 1 provided by the present invention might enable to reduce a system space and to address and solve the cooling-related problem of the controller. Especially, the appropriate combination of two water pumps enhances a ratio of a head of the pump to a flow rate of the pump to thereby effectively eliminate a high-temperature heat-emitting problem of a pump controller or a motor due to the scale-up of the water pump.

As described above, the radiator module 1 for a fuel cell vehicle according to the present invention has the following advantages. An electronic water pump, a pump controller and a radiator unit are integrally formed into a single module in a cooling water circulation system of the fuel cell vehicle so that the water pump and the pump controller can be integrally mounted inside the radiator module to thereby promote spatial efficiency. Also, the efficiency of cooling performance can be improved while not impairing a separation plate of a fuel cell stack using a method of increasing a flow rate by interconnecting two water pumps flow passages between the inlet port and the outlet of the radiator unit. Furthermore, since the pump controller is disposed inwardly from the shroud, it can be cooled by a flow of air generated by the radiator fan.

Ultimately, the modulization of related components enables to make the fuel cell system compact and to reduce parts price.

The forgoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiment were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the claims appended hereto and their equivalents.

What is claimed is:

1. A radiator module for a fuel cell vehicle, integrally comprising:
a radiator unit mounted in a cooling system of the fuel cell vehicle, the radiator unit including an inlet port, an outlet port and a radiator fan;
at least a water pump installed inside the inlet port and the outlet port of the radiator unit, respectively; and
a pump controller mounted at one side of a rear portion of the radiator module for controlling the water pumps, the pump controller being cooled by a flow of air generated from the radiator unit.

2. The radiator module according to claim 1, wherein each of the water pumps is installed at the radiator unit in such a fashion that an impeller thereof is disposed substantially along a perpendicular line extending from a front wall surface of the radiator module.

3. The radiator module of claim 1, wherein the radiator unit comprises at least a fluid flow guide vane formed convexly in a streamlined and tapered shape on a rear wall surface thereof in such a fashion as to be positioned opposite to the inlet port and the outlet port, respectively, so as to induce a flow of water therethrough.

4. The radiator module of claim 1, wherein the pump controller comprises a radiation block having at least a radiation fin formed at least at one side thereof.

5. The radiator module of claim 1 or 2, wherein the water pump installed inside the outlet port of the water pumps is configured to rotate at a speed of about 200 to 500 rpm lower than that of the water pump installed inside the inlet port.
